(19) United States
(12) Patent Application Publication
(10) Pub. No.: US 2006/0268393 A1
(43) Pub. Date: Nov. 30, 2006

(54) System and method for generating supercontinuum light

(75) Inventor: Mohammed N. Islam, Ann Arbor, MI (US)

Correspondence Address: BAKER BOTTS L.L.P., 2001 ROSS AVENUE, SUITE 600, DALLAS, TX, 75201-2980, US

(73) Assignee: Omni Sciences, Inc.

(21) Appl. No.: 11/335,998

(22) Filed: Jan. 20, 2006

Related U.S. Application Data
(60) Provisional application No. 60/646,143, filed on Jan. 21, 2005.

(51) Int. Cl. H01S 3/00; H04B 10/12

(52) U.S. Cl. 359/337.5

(57) ABSTRACT

A supercontinuum light source includes a modulated pump laser, a first fiber, and a nonlinear waveguide. The modulated pump laser generates light comprising longer pulses, where a longer pulse has a temporal duration of approximately ten picoseconds or more. The first fiber breaks at least one longer pulse into shorter pulses, where a shorter pulse has a temporal duration of approximately two picoseconds or less. The first fiber at least partially operates in an anomalous group velocity dispersion regime, and the shorter pulses result from a modulational instability in the first fiber. The nonlinear waveguide spectrally broadens the shorter pulses to yield supercontinuum light, where the supercontinuum light has a spectral width of approximately 150 nanometers or more.

### RELATED APPLICATION

This application claims benefit under 35 U.S.C. § 119(e) of U.S. Provisional Application Ser. No. 60/646,143, entitled “LASER-DIODE BASED SUPERCONTINUUM LIGHT SOURCE AND APPLICATIONS IN OPTICAL COHERENCE TOMOGRAPHY,” Attorney's Docket 076196.0102, filed Jan. 21, 2005, by Mohammed N. Islam.

### GOVERNMENT FUNDING

The U.S. Government may have certain rights in this invention as provided for by the terms of Contract No. W911NF-04-C-0078 awarded by Army Research Office of the U.S. Army.

### TECHNICAL FIELD

This invention relates generally to the field of light sources and more specifically to a system and method for generating supercontinuum light.

### BACKGROUND

Optical coherence tomography (OCT) is an imaging technique that may be used to image samples such as biological tissues. In an OCT system, a light source emits light, which is split into a reference beam and a sample beam. The reference beam is directed through a path. The sample beam is directed through another path that includes reflection from a sample. The reflected light includes image information describing the sample. An interference pattern of the interference between the reference beam and the sample beam is generated, and the image information describing the sample is established from the interference pattern.

The spectrum of the light generated by the light source may affect the resolution of the resulting image. In general, a broader spectrum may improve the resolution. Known light sources for OCT systems, however, are unsatisfactory in certain situations. For example, certain light sources are complicated, large, and expensive. It is generally desirable to have satisfactory light sources for OCT systems in certain situations.

### SUMMARY OF THE DISCLOSURE

In accordance with the present invention, disadvantages and problems associated with previous techniques for generating supercontinuum light may be reduced or eliminated.

According to one embodiment of the present invention, a supercontinuum light source includes a modulated pump laser, a first fiber, and a nonlinear waveguide. The modulated pump laser generates light comprising longer pulses, where a longer pulse has a temporal duration of approximately ten picoseconds or more. The first fiber breaks at least one longer pulse into shorter pulses, where a shorter pulse has a temporal duration of approximately two picoseconds or less. The first fiber at least partially operates in an anomalous group velocity dispersion regime, and the shorter pulses result from a modulational instability in the first fiber. The nonlinear waveguide spectrally broadens the shorter pulses to yield supercontinuum light, where the supercontinuum light has a spectral width of approximately 150 nanometers or more.

Certain embodiments of the invention may provide one or more technical advantages. A technical advantage of one embodiment may be that pulses of the light are broken into pulses having a shorter temporal duration. The pulses are then spectrally broadened to create supercontinuum light. The supercontinuum light may have a spectral width of approximately 150 nanometers (nm) or more. Another technical advantage of one embodiment may be that the supercontinuum light may be generated with a modulated pump laser, a fiber, and a nonlinear waveguide.

Certain embodiments of the invention may include none, some, or all of the above technical advantages. One or more other technical advantages may be readily apparent to one skilled in the art from the figures, descriptions, and claims included herein.

### BRIEF DESCRIPTION OF THE DRAWINGS

For a more complete understanding of the present invention and its features and advantages, reference is now made to the following description, taken in conjunction with the accompanying drawings, in which:

FIG. 1 is a block diagram illustrating an optical coherence tomography (OCT) system that may include one embodiment of a supercontinuum light source;

FIG. 2 is a block diagram illustrating one embodiment of a supercontinuum light source that may be used with the OCT system of FIG. 1;

FIG. 3 is a diagram of graphs illustrating example spectrums of light processed by the light source of FIG. 2;

FIG. 4 is a diagram of a graph illustrating an example spectrum of supercontinuum light generated by the light source of FIG. 2;

FIG. 5 is a diagram of a graph illustrating an example spectrum of supercontinuum light generated by the light source of FIG. 2;

FIG. 6 is a block diagram illustrating one embodiment of a measurement system that may be used to measure the axial resolution of an OCT system having the light source of FIG. 2;

FIGS. 7 and 8 are diagrams of graphs illustrating an example interferogram generated by the measurement system of FIG. 6;

FIG. 9 is a block diagram illustrating one embodiment of a system that includes a modulated pump laser and a fiber that may be used with the light source of FIG. 2;

FIG. 10 is a block diagram illustrating one embodiment of a test system that may be used to assess the impact of modulational instability on the generation of supercontinuum light by the light source of FIG. 2;

FIG. 11 is a diagram of a graph illustrating an example spectrum generated by the test system of FIG. 10;

FIG. 12 is a diagram of graphs illustrating the flatness of an example spectrum generated by the test system of FIG. 10;

FIG. 13 is a diagram of graphs illustrating example spectral densities generated by the test system of FIG. 10; and

FIGS. 14 and 15 are diagrams of graphs illustrating example temporal autocorrelation generated by the test system of FIG. 10.

### DETAILED DESCRIPTION OF THE DRAWINGS

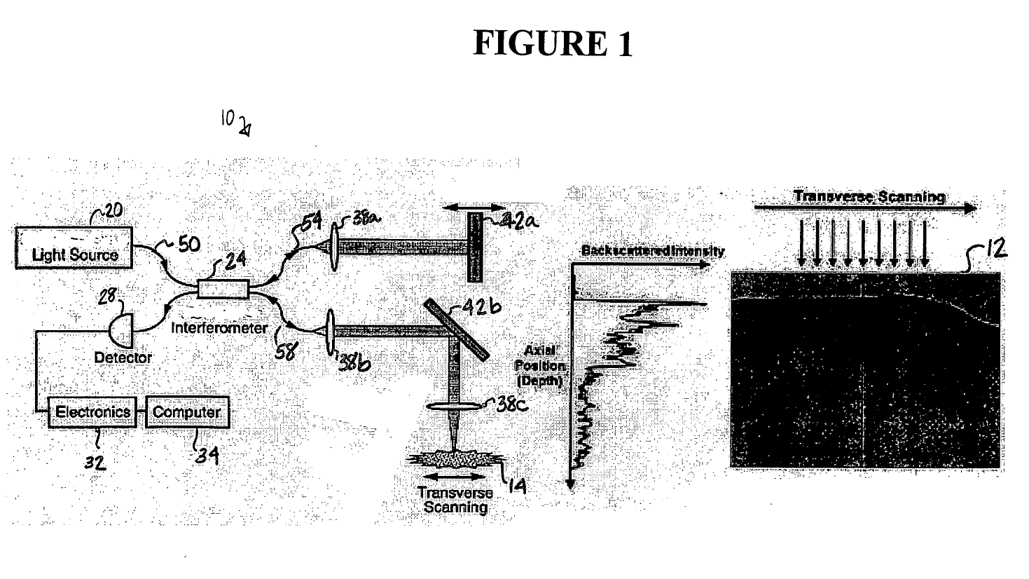

Embodiments of the present invention and its advantages are best understood by referring to FIGS. 1 through 15 of the drawings, like numerals being used for like and corresponding parts of the various drawings.

FIG. 1 is a block diagram illustrating an optical coherence tomography (OCT) system 10 that may include one embodiment of a supercontinuum light source. According to the embodiment, the supercontinuum light source breaks light pulses having a longer temporal duration into pulses having a shorter temporal duration. The supercontinuum light source then spectrally broadens the pulses to create supercontinuum light. The supercontinuum light may have a spectral width of approximately 150 nm or more.

According to the illustrated embodiment, OCT system 10 may be used to generate an image 12 of a sample 14. Sample 14 may comprise any suitable tissue, such as in vivo biological tissue. Sample 14 may be imaged for use in any suitable area, such as ophthalmology, dermatology, cardiology, urology, endoscopy, arthroscopy, other area that may utilize tissue imaging, or any combination of the preceding.

Ophthalmology may utilize tissue imaging to diagnose retinal and macular diseases, diabetic retinopathy, or other conditions. Dermatology may utilize tissue imaging to diagnose skin diseases and to detect skin cancers. Cardiology may utilize tissue imaging to detect vulnerable plaque, atherosclerosis, or coronary heart disease. Urology may utilize tissue imaging to detect infection, urothelial precancer, bladder cancer, or benign and malignant growths in the prostrate. Endoscopy may utilize tissue imaging to detect gastrology disorders. Arthroscopy may utilize tissue imaging to perform surgical operations.

According to the illustrated embodiment, OCT system 10 includes a light source 20, an interferometer 24, a detector 28, electronics 32, a computer 34, focusing elements 38, and reflective surfaces 42 coupled as shown. According to one embodiment of operation, light source 20 emits light 50. Interferometer 24 splits light 50 into a reference beam 54 and a sample beam 58. Focusing element 38a directs reference beam 54 to reflective surface 42a, which reflects reference beam 54 back through focusing element 38a to interferometer 24. Focusing element 38b directs sample beam 58 towards reflective surface 42b, which reflects sample beam 58 towards focusing element 38c.

Focusing element 38c directs sample beam 58 towards sample 14, which reflects sample beam 58 towards reflective surface 42b. Sample beam 58 reflected from sample 14 includes image information about sample 14. Reflective surface 42b reflects sample beam 58 back through focusing element 38b to interferometer 24. Interferometer 24 generates an interference pattern that describes the interference between reference beam 54 and sample beam 58. The interference pattern may be used to establish the image information.

Interferometer 24 may comprise a fiber-based Michelson interferometer, and may have a resolution of approximately 10 microns or less. Detector 28 detects the interference pattern from interferometer 24, and generates an output signal describing the interference pattern. Electronics 32 process the output signal so that the signal may be analyzed by computer 34. Computer 34 analyzes the output signal to establish the image information from the interference pattern.

Typically, the characteristics of light 50 from light source 20 affects the effectiveness and efficiency of OCT system 10. As a first example, the spectral bandwidth of light 50 affects the axial (longitudinal) resolution of image 12. Bandwidths of approximately 1300 to 1600 nm may yield resolutions of approximately 1.1 to 1.4 microns. As a second example, the center wavelength of light 50 affects the penetration depth through sample 14. In general, scattering loss scales as 1/λ^{k}, that is, longer wavelengths exhibit less scattering. In addition, water absorption becomes important for near-infrared (IR) wavelengths, particularly for wavelengths greater than 1.9 microns. In a wavelength range of approximately 1.5 microns, approximately 2 to 3 mm penetration depth may be achieved. As a third example, the power density light source 20 affects the data acquisition time of OCT system 10.

According to one embodiment, light source 20 may comprise a supercontinuum light source. According to the embodiment, light source 20 includes a modulated pump laser, a fiber, and a nonlinear waveguide. The modulated pump laser generates light with pulses having a temporal duration greater than 10 picoseconds (psec). Temporal duration may be defined as the pulse width between the 20 decibel (dB) down (or 1%) points from the peak of the pulse intensity. The fiber breaks the pulses of the light into pulses having a shorter temporal duration, such as less than 2 psec. The nonlinear waveguide spectrally broadens the pulses to create supercontinuum light.

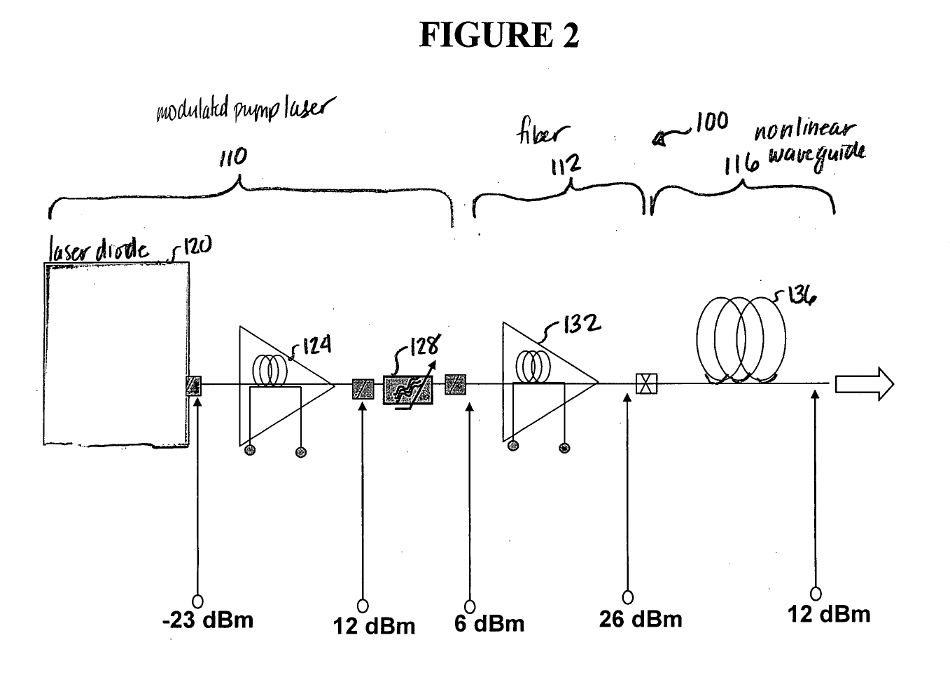

According to one embodiment, the supercontinuum light may have a spectral width of approximately 150 nm or more and a long wavelength edge of approximately 1.8 microns or more. The supercontinuum light may yield improved resolution. An example light source 20 is described in more detail with reference to FIG. 2.

One or more components of system 10 may include appropriate input devices, output devices, processors, memory, or other components for receiving, processing, storing, and communicating information according to the operation of system 10. As an example, one or more components of system 10 may include logic, an interface, memory, other component, or any suitable combination of the preceding. “Logic” may refer to hardware, software, other logic, or any suitable combination of the preceding. Certain logic may manage the operation of a device, and may comprise, for example, a processor. “Processor” may refer to any suitable device operable to execute instructions and manipulate data to perform operations.

“Interface” may refer to logic of a device operable to receive input for the device, send output from the device, perform suitable processing of the input or output or both, or any combination of the preceding, and may comprise one or more ports, conversion software, or both. “Memory” may refer to logic operable to store and facilitate retrieval of information, and may comprise Random Access Memory (RAM), Read Only Memory (ROM), a magnetic drive, a disk drive, a Compact Disk (CD) drive, a Digital Video Disk (DVD) drive, removable media storage, any other suitable data storage medium, or a combination of any of the preceding.

Modifications, additions, or omissions may be made to system 10 without departing from the scope of the invention. The components of system 10 may be integrated or separated according to particular needs. Moreover, the operations of system 10 may be performed by more, fewer, or other modules. Additionally, operations of system 10 may be performed using any suitable logic. As used in this document, “each” refers to each member of a set or each member of a subset of a set.

FIG. 2 is a block diagram illustrating one embodiment of a supercontinuum light source 100 that may be used with OCT system 10 of FIG. 1. According to the illustrated embodiment, light source 100 includes a modulated pump laser 110, a fiber 112, and a nonlinear waveguide 116 coupled as shown. Modulated pump laser 110 generates pulsed light. According to one embodiment, the light may have pulses having a temporal duration greater than 10 psec. Fiber 112 breaks the pulses into pulses having a shorter temporal duration. According to one embodiment, the pulses may have a temporal duration of less than 2 psec. Nonlinear waveguide 116 spectrally broadens the pulses to create supercontinuum light. According to one embodiment, the supercontinuum light may have a spectral width of approximately 150 nm or more and a long wavelength edge of approximately 1.8 microns or more.

The supercontinuum feature of light may be initiated by modulational instability. Modulational instability refers to the parametric amplification that occurs when the nonlinearity of a fiber is involved in phase matching. At least a portion of the fiber operates in the anomalous group velocity dispersion regime, in which the wavelengths are longer than the zero dispersion wavelength of the fiber.

Modulational instability breaks up a continuous wave (CW) or quasi-CW wave into shorter pulses. Side-bands, which may be seeded by the longitudinal modes of the laser diode, are generated from the interplay between the nonlinearity and dispersion. The generation of the side-bands leads to the formation of pulses from a quasi-CW background. When the wave breaks up into shorter pulses, the peak intensity of the pulses increases. Other nonlinear effects may also occur. For example, the increased intensity may lead to self-phase modulation, cross-phase modulation, four-wave mixing, and the Raman effect. One or more of these nonlinear effects may broaden the spectrum to yield supercontinuum light.

According to one embodiment, modulated pump laser 110 generates pulsed light. The light may have any suitable wavelength, such as approximately 1.4 to 1.7 microns. The pulses may have any suitable temporal duration, such as approximately 100 psec or longer or approximately one nanosecond (ns) or longer.

According to the illustrated embodiment, modulated pump laser 110 includes one or more laser diodes 120, an optical amplifier 124, a filter system 128. According to one embodiment of operation, laser diodes 120 generate light, optical amplifier 124 increases the power of the light, and filter system 128 reduces or blocks unwanted features, such as amplified spontaneous emission (ASE).

Laser diode 120 generates light. Laser diode 120 may comprise any suitable diode operable to generate light, such as a pulsed distributed feedback laser diode (DFB-LD) or a Fabry-Perot laser diode. The light may have any suitable power, such as approximately −23 decibels referred to 1 milliwatt (dBm). The light may have pulses of any suitable width and repetition rate. For example, the pulse width may be greater than 10 psec, such as approximately 1.8 ns, and the repetition rate may be in a range of several hertz (Hz) to hundreds of megahertz (mHz), such as approximately 500 kilohertz (kHz).

Optical amplifier 124 increases the power of light to any suitable power level, such as approximately 12 dBm. Optical amplifier 124 may comprise any suitable optical amplifier. Example optical amplifiers include erbium-doped fiber amplifiers (EDFA), other rare earth doped fiber amplifiers, Raman amplifiers, or semiconductor amplifiers. Optical amplifier 124 may have one or more stages. One or more filters, such as spectral or temporal filters, may be placed between or after stages to control the level of amplified spontaneous emission (ASE).

Filter system 128 reduces or blocks unwanted features, such as amplified spontaneous emission (ASE). Filter system 128 may comprise one or more wavelength filters and a temporal modulator that is synchronized with the light pulses. Filter system 128 may pass through the light with an insertion loss that reduces or blocks the unwanted features. The insertion loss may have any suitable value, such as approximately 6 dBm, and may be passed through to high-power pre-amplifier 132.

Fiber 112 breaks the pulses of the pulsed light from modulated pump laser 110 into pulses having a shorter temporal duration. Fiber 112 may at least partially operate in the anomalous group velocity dispersion regime, and may break pulses through modulational instability. Fiber 112 may comprise any suitable fiber, such as a fused silica fiber, a high-nonlinearity fiber, an optical amplifier, an erbium-doped fiber, a photonic crystal fiber, a dispersion compensating fiber, a dispersion shifted fiber, a non-zero dispersion fiber, a dispersion flattened fiber, a patch-cord fiber, or a low bend loss fiber.

According to the illustrated embodiment, fiber 112 comprises a high-power amplifier 132. High-power amplifier 132 increases the power output of the light to a predetermined average power. The average power may have any suitable value, for example, approximately 26 dBm, which corresponds to a duty cycle of 830:1 for a peak power of approximately 300 watts (W), and a pulse energy of approximately 0.5 millijoules (mJ). High-power amplifier 132 may comprise any suitable optical amplifier, such as those described with reference to optical amplifier 124.

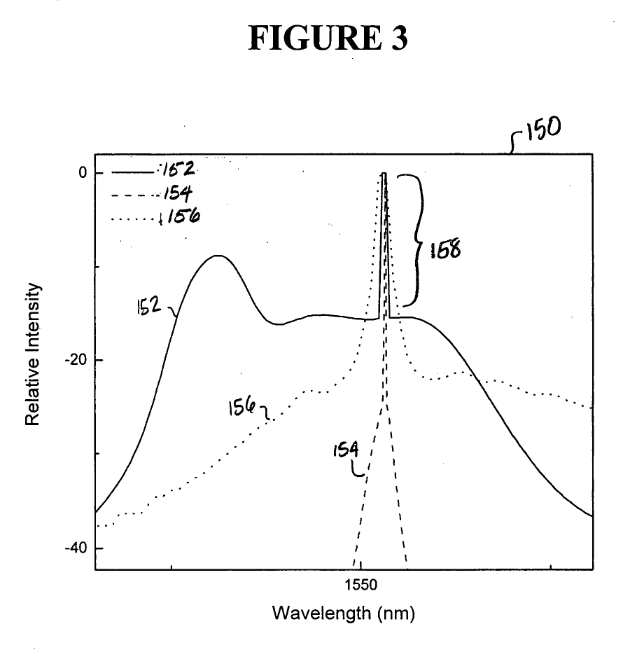

Optical amplifiers 124 and 132 may process light of any suitable spectrum. Example spectrums are described with reference to FIG. 3.

FIG. 3 is a diagram 150 of graphs 152, 154, and 156 illustrating example spectrums of light processed by optical amplifiers 124 and 132. The spectrum of light is given by the relative intensity of the light at a wavelength. Graph 152 illustrates the spectrum of light output by optical amplifier 124, graph 154 illustrates the spectrum of light input to optical amplifier 132, and graph 156 illustrates the spectrum of light output by optical amplifier 132. Graphs 152, 154, and 156 exhibits peaks 158 corresponding to amplified light from laser diode 120. The light has an exemplary wavelength of 1553 nm.

Referring back to FIG. 2, nonlinear waveguide 116 spectrally broadens the pulses from fiber 112 to yield supercontinuum light. The supercontinuum light may have any suitable power, for example, 12 dBm. According to the illustrated embodiment, nonlinear waveguide 116 includes one or more fibers 136. Fibers 136 may comprise one or more of any suitable fiber, and may comprise at least a portion of a fiber used for optical amplification, such as fiber 112. Fibers 136 can be spliced together to optimize the dispersion profile and nonlinear effects.

Fibers 136 may be selected to have a smaller effective area and a dispersion zero that can be shifted to a wider range of wavelengths. Moreover, fibers 136 may be selected to have, at least in some portions, anomalous group velocity dispersion at the wavelengths covered by the supercontinuum wavelengths or the pump wavelengths. Examples of fiber 136 include a fused silica fiber, a high-nonlinearity fiber (such as fibers that have an effective nonlinear coefficient γ>2 km⁻¹W⁻¹, γ>2.2 km⁻¹W⁻¹, or γ>3 km⁻¹W⁻¹), a non-zero dispersion shifted fiber, a dispersion compensating fiber, a dispersion flattened fiber, a photonic crystal fiber, a fluoride fiber, a chalcogenide fiber, a low bend loss fiber, an erbium doped fiber, or a tellurite fiber.

According to another embodiment, nonlinear waveguide 116 may comprise a waveguide made from semiconductor material, nonlinear glasses (such as chalcogenide, fluoride, or tellurite glasses), or hollow-core fibers or capillaries filled with nonlinear materials such CS₂. Examples of semiconductor waveguides include waveguides comprising silicon, GaAs/AlGaAs, or GaP. According to yet another embodiment, nonlinear waveguide 116 may comprise bulk semiconductor wafers or bulk glasses such as in chalcogenides, fluorides, or tellurites.

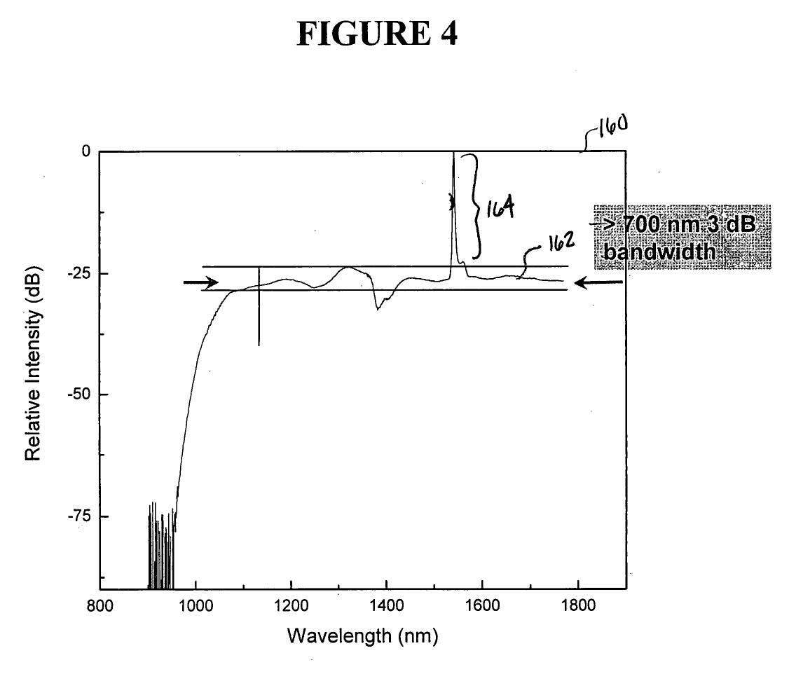

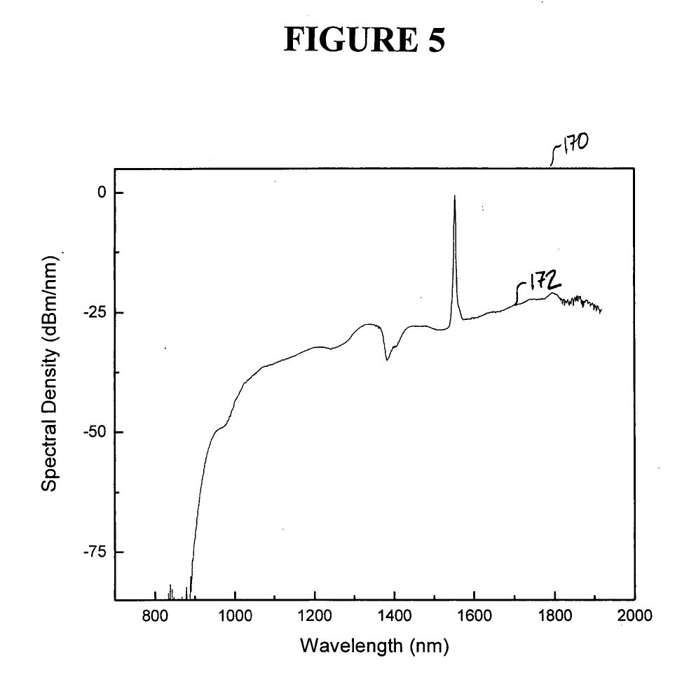

Fiber 136 may have any suitable core size, for example, approximately 30 microns or less, such as 8 microns or less. The core size may refer to, for example, the diameter of the core of the fiber or waveguide. Fiber 136 may have any suitable length, for example, between 1 centimeter (cm) to 1 meter (m) to 100 kilometers (km), such as approximately 400 m. Propagating supercontinuum light through fiber may lead to dispersive effects and spectral slope through the Raman effect, so the length may be selected to remove the supercontinuum light immediately after it is generated to optimize spectral flatness. Example spectrums of supercontinuum light generated by light source 100 are described with reference to FIGS. 4 and 5.

FIG. 4 is a diagram 160 of a graph 162 illustrating an example spectrum of supercontinuum light generated by light source 100. Graph 162 illustrates a spectrum with a 3 dB bandwidth of greater than 700 nm. Undulation in the spectrum may be due to water absorption in the fiber. Graph 162 has an ASE peak 164 near 1540 nm that may correspond to residual pump and ASE emitted from amplifier 112.

FIG. 5 is a diagram 170 of a graph 172 illustrating an example spectrum of supercontinuum light generated by light source 100. Graph 172 illustrates a spectrum with bandwidth from approximately 900 nm to approximately 1900 nm. The long wavelength side may be limited by the transmission of the fiber and water absorption, while the short wavelength side may be limited by the cut-off wavelength of the fiber. The spectral density is between approximately −30 dBm/nm to approximately −23 dBm/nm over a large fraction of the spectral width.

Referring back to FIG. 2, in certain cases, supercontinuum light source 100 may provide advantages to OCT system 10. As a first example, light source 100 may generate light with high output power and high spectral density. As a second example, light source 100 may generate light with a flat spectrum, which may yield higher axial resolution without shadow effects. As a third example, light source 100 may generate light with high spatial coherence, which may enable tight focusing and high lateral resolution. As a fourth example, light source 100 may generate light with low temporal coherence, which may allow OCT system 10 to achieve a resolution below 10 microns, even approaching 1 micron.

Modifications, additions, or omissions may be made to light source 100 without departing from the scope of the invention. The components of light source 100 may be integrated or separated according to particular needs. Moreover, the operations of light source 100 may be performed by more, fewer, or other modules. Additionally, operations of light source 100 may be performed using any suitable logic.

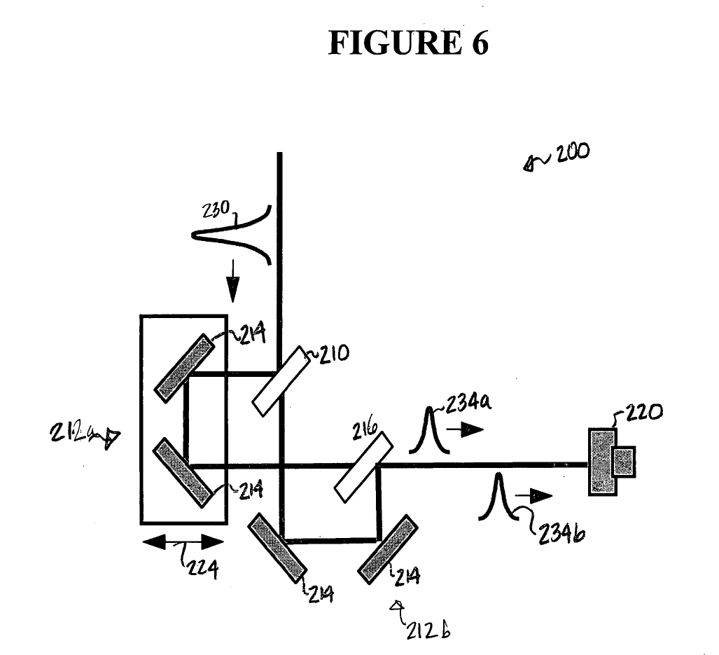

FIG. 6 is a block diagram illustrating one embodiment of a measurement system 200 that may be used to measure the axial resolution of an OCT system having supercontinuum light source 100 of FIG. 2. According to the illustrated embodiment, measurement system 200 comprises a Michelson Interferometer (MI) that includes arms 212a-b and a detector 220 coupled as shown.

An arm 212 may include a beam splitter 210, reflective surfaces 214, and a beam combiner 216 coupled as shown. Arms 212a-b receive light having pulses 230, split the light, and output light having pulses 234, where pulses 234a are delayed with respect to pulses 234b. Arms 212a-b may be optimally balanced such that the same amount of dispersion is incurred in each arm 212. A variable delay 224 may be introduced using a stepper-motor controlled delay stage with a 0.1 micron resolution.

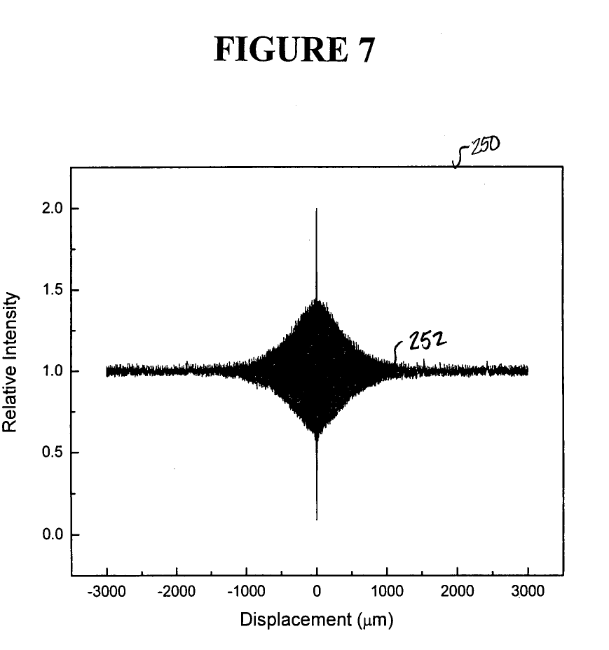

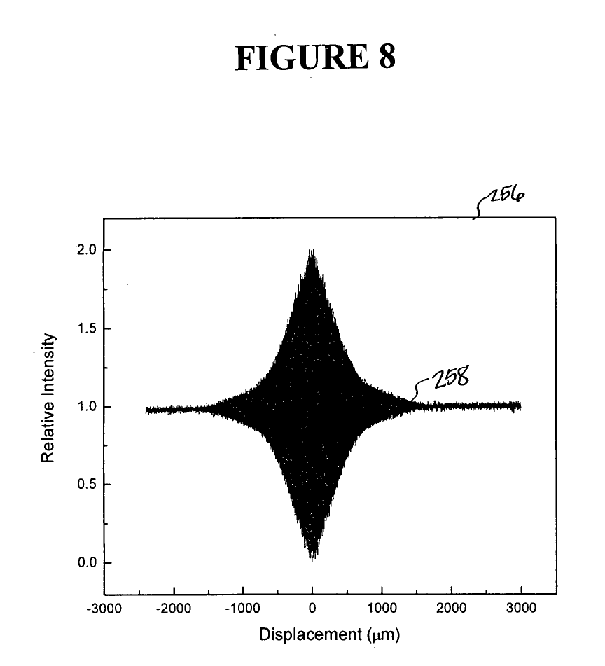

Detector 220 detects pulses 234 and generates interferograms of pulses 234. Example interferograms are described with reference to FIGS. 7 and 8. Detector 220 may comprise a InGaAs detector with a bandwidth between 950 nm and 1675 nm. In another embodiment, detector 220 may comprise InAs, which may be sensitive out to approximately 3.5 microns. In yet another embodiment, detector 220 may comprise InSb, which may be sensitive out to approximately 4.6 microns, or HgCdTe, which may be sensitive out to approximately 6 microns or more.

According to one embodiment, detector 220 may have increased bandwidth, which may yield a decrease in sensitivity or an increase in noise. Any suitable approach may be used to compensate for these effects. As an example, an electrical pre-amplifier may be used to compensate for the decrease in sensitivity. As another example, electrical bandwidth filters may be used to limit the electrical pass-band and reduce the noise. As another example, optical losses in fibers and optics may be reduced to boost the optical signal at detector 220.

FIGS. 7 and 8 are diagrams of graphs illustrating an example interferogram generated by measurement system 200 of FIG. 6. FIG. 7 is a diagram 250 of a graph 252 illustrating an example interferogram. An interferogram may be given by relative intensity versus displacement. Graph 252 has a narrow peak around zero displacement that corresponds to the supercontinuum light.

Graph 252 also has a broad feature that corresponds to the ASE emitted from optical amplifiers 124 and 132. The broad feature has a full-width at half maximum (FWHM) of approximately 760 microns. The ASE may be reduced. The supercontinuum light is generated when laser diode 120 is on. When laser diode 120 is off, optical amplifier 124 continues to generate ASE, which is further amplified by optical amplifier 132. The ASE may be reduced by, for example, blocking the ASE when laser diode 120 is off or detecting output only when laser diode 120 is on. If the ASE peak is assumed to be reduced by 20 dB, the resulting interferogram may correspond essentially to the narrow feature of graph 252 without the ASE pedestal.

FIG. 8 is a diagram 260 of a graph 262 illustrating an example interferogram generated when laser diode 120 is off, leaving the pump lasers on to optical amplifiers 124 and 132. Graph 262 has a FWHM width of approximately 730 microns.

Referring back to FIG. 6, measurement system 200 may process an interferogram from detector 220 to obtain an expected axial resolution. The coherence length may be defined as the FWHM of the field autocorrelation measured by the interferometer. The resolution within a sample may be estimated by dividing the free-space resolution by the group refractive index of the sample. The free space resolution of 250 may be 3.2 microns, and the group refractive index for most biological tissues may be approximately 1.4, yielding a resolution of approximately 2.3 microns.

Measurement system 200 may process the portion of an interferogram that corresponds to a flatter portion of the spectrum to obtain an expected axial resolution. The free-space resolution for the portion may be 1.9 microns, yielding a resolution of approximately 1.4 microns. If the response of detector 220 is assumed to be flat to 2000 nm, the resolution may be estimated to be approximately 1.1 microns.

Modifications, additions, or omissions may be made to measurement system 200 without departing from the scope of the invention. The components of measurement system 200 may be integrated or separated according to particular needs. Moreover, the operations of measurement system 200 may be performed by more, fewer, or other modules. Additionally, operations of measurement system 200 may be performed using any suitable logic.

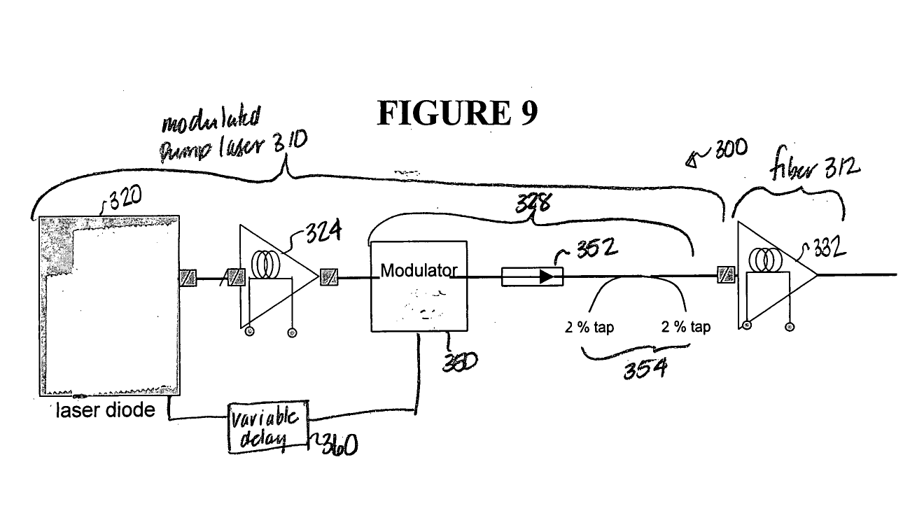

FIG. 9 is a block diagram illustrating one embodiment of a system 300 that includes a modulated pump laser 310 and a fiber 312 that may be used with light source 100 of FIG. 2. Modulated pump laser 310 may reduce ASE by blocking the ASE when a laser diode is off.

According to the illustrated embodiment, system 300 includes modulated pump laser 310 and fiber 312. Modulated pump laser 310 includes one or more laser diodes 320, an optical amplifier 324, and a filter system 328. Laser diodes 320 and optical amplifier 324 may be substantially similar to laser diodes 120 and optical amplifier 124 of FIG. 2. Fiber 312 includes optical amplifier 332, which may be substantially similar to optical amplifier 132 of FIG. 2.

According to the illustrated embodiment, filter system 328 includes a modulator 350, an isolator 352, and taps 354. Modulator 350 blocks ASE when laser diode 320 is off, which may at least reduce the ASE. Modulator 350 may comprise any suitable modulator, for example, a fiber pigtailed modulator. The modulator window of modulator 350 may be synchronized to the laser drive of laser diode 320 to block the ASE when a laser diode 320 is off.

The selection of modulator 350 may be made according to any suitable factors. As an example, modulator 350 may be selected such that the on-off contrast ratio of modulator 350 can allow modulator 350 to be synchronized with the laser drive of laser diode 320. As another example, modulator 350 may be selected such that the insertion loss resulting from modulator 350 is acceptable.

Moreover, the placement of modulator 350 may be determined according to any suitable factors. As an example, modulator 350 may be placed to reduce insertion loss and noise. Although modulator 350 is illustrated as placed after optical amplifier 324, modulator 350 may be placed after optical amplifier 332 or after nonlinear waveguide 116 of FIG. 2.

Furthermore, other devices may be used with modulator 350. As an example, a variable delay 360 such as a variable electrical delay line may be used to compensate for the delay to optical amplifier 324. As another example, a polarization controller may be placed prior to modulator 350 to control polarization.

Modifications, additions, or omissions may be made to system 300 without departing from the scope of the invention. The components of system 300 may be integrated or separated according to particular needs. Moreover, the operations of system 300 may be performed by more, fewer, or other modules. Additionally, operations of system 300 may be performed using any suitable logic.

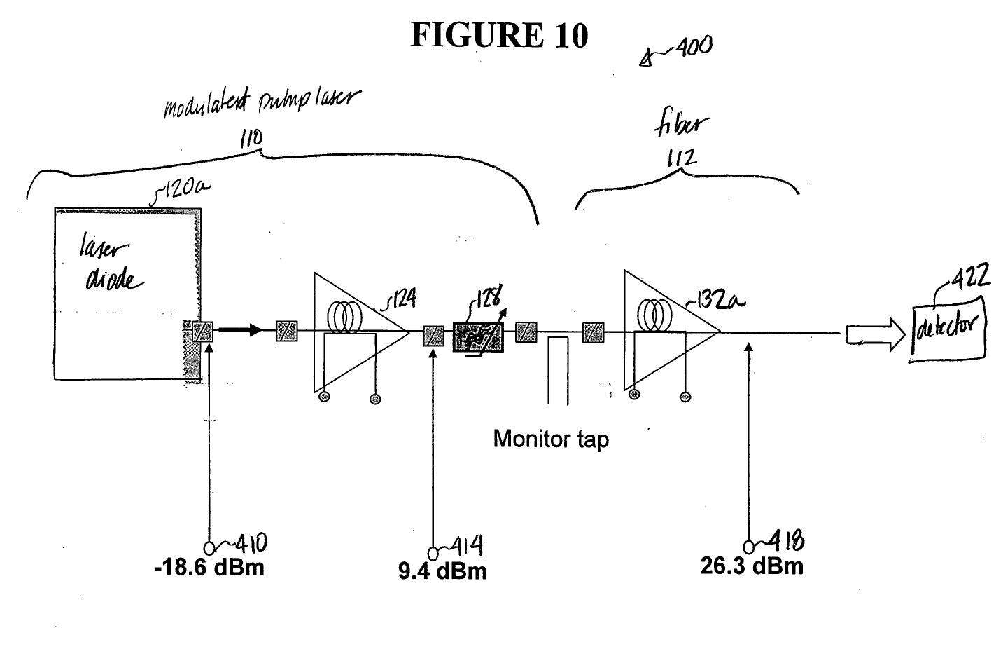

FIG. 10 is a block diagram illustrating one embodiment of a test system 400 that may be used to assess the impact of modulational instability on the generation of supercontinuum light by supercontinuum light source 100 of FIG. 2. According to the illustrated embodiment, test system 400 includes components of supercontinuum light source 100. The components of test system 400 may be substantially similar to the components of supercontinuum light source 100, with any suitable exceptions. For example, laser diode 120a may comprise a Fabry-Perot laser diode, and optical amplifier 132a may output the supercontinuum light. According to the illustrated embodiment, test system 400 includes detectors 410, 414, 418, and 422, which may comprise power meters, spectrometers, optical spectrum analyzers, or other suitable detectors for detecting light. The time-averaged power measured at points 410, 414, 418, and 422 may be as indicated in FIG. 10.

Laser diode 120a may generate light having any suitable pulses, for example, approximately 8 ns pulses at a 200 KHz repetition rate. As another example, the laser diode may deliver approximately 1.8 ns pulses at a 5 KHz repetition rate. Laser diode 120a may be selected to generate light with multiple longitudinal modes to seed the modulational instability process. Alternatively, the modulational instability process may be seeded from noise, such as noise introduced by ASE. In one embodiment, laser diode 120a may comprise a distributed feedback laser diode operating near 1550 nm, and the seed may be the ASE peak near 1530 nm from the erbium-doped fiber amplifiers. In yet another embodiment, a separate seed laser may be used to seed the modulational instability.

Optical amplifier 124 may output light that exhibits ASE, which may introduce noise that may be used to seed the modulational instability process. Filter system 128 filters at least some of the ASE, and may include a spectral and/or a temporal filter. A spectral filter may be used to block out-of-band ASE, and a temporal filter may be used to block ASE not timed with the signal pulses, both in-band and out-of-band.

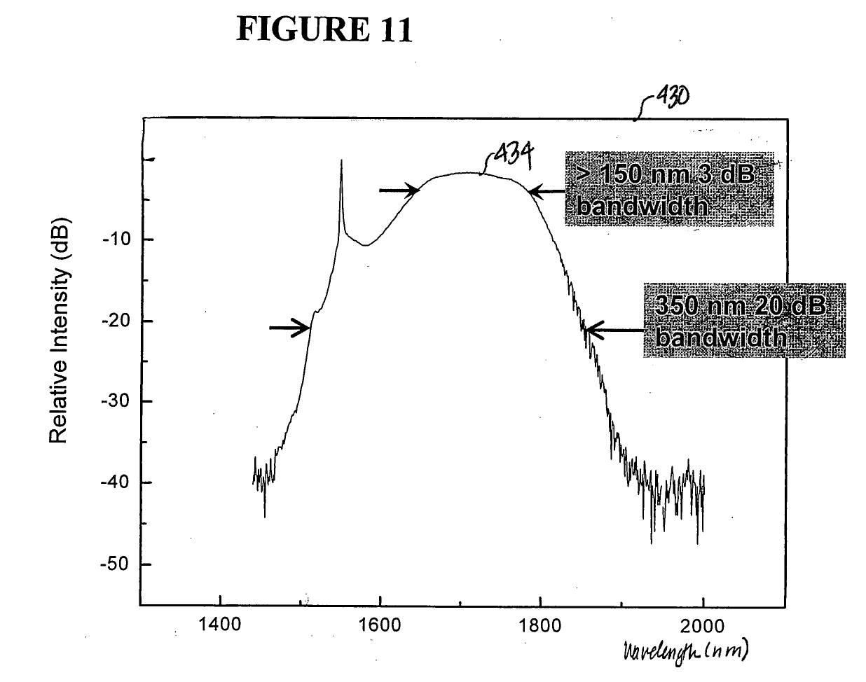

Optical amplifier 132a outputs the supercontinuum light. Optical amplifier 132 may output the supercontinuum light through a fiber patch cord to detectors 422. Detectors 422 generate detector data in response to the supercontinuum light. Example detector data is described with reference to FIGS. 11 through 15.

FIGS. 11 through 15 are diagrams illustrating example detector data generated by test system 400. FIG. 11 is a diagram 430 of a graph 434 illustrating an example spectrum of the supercontinuum light. The spectrum has a 3 dB bandwidth of greater than 150 nm and a 20 dB bandwidth of approximately 350 nm. Fiber 136 of FIG. 2 may be used to broaden the spectrum.

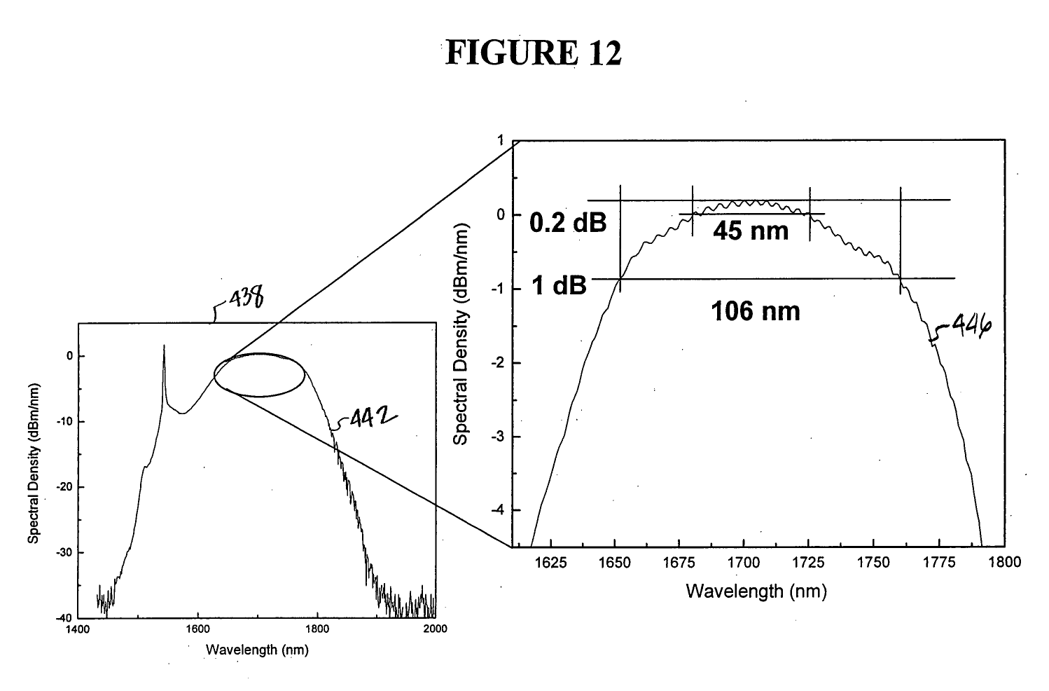

FIG. 12 is a diagram 438 of graphs 442 and 446 that illustrate the flatness of an example spectrum. For example, the 0.2 dB bandwidth is approximately 45 nm, while the 1 dB bandwidth is approximately 106 nm. Different techniques may be used to increase the flatness of the spectrum. As an example, fiber 136 of FIG. 2 may be selected to improve the flatness. As another example, the spectrum may be flattened by adjusting signal processing and averaging to improve the signal-to-noise ratio for OCT system 100. As another example, gain equalization may be used to improve the flatness.

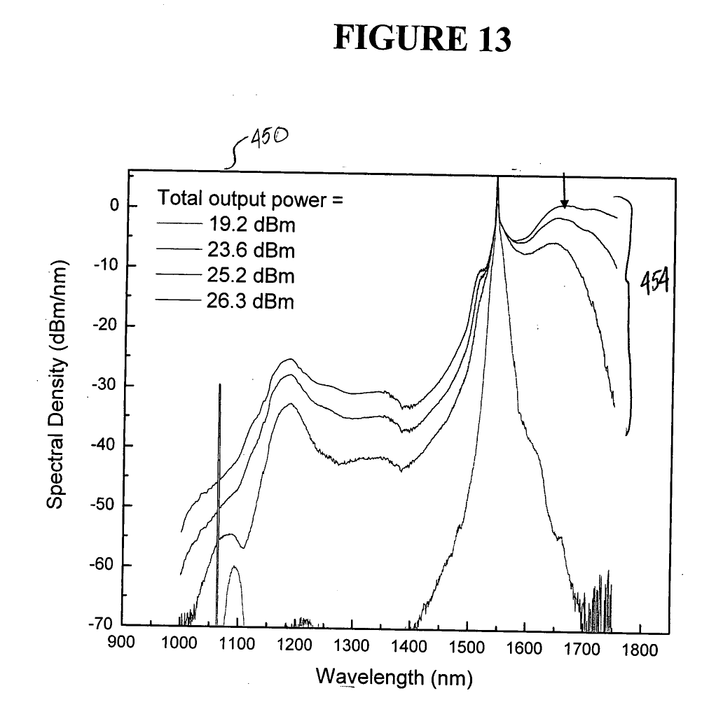

FIG. 13 is a diagram 450 of graphs 454 illustrating example spectral density at different output powers of optical amplifier 132. The spectral density shown in the graphs corresponds to the time-averaged spectral density. Graphs 454 exhibit a very high spectral density as high as greater than 1 milliwatt per nanometer (mW/nm). Over a substantial portion of the super-continuum spectrum, the time-averaged spectral density is greater than −26 dBm/nm. In other cases, the time-averaged spectral density may be greater than −30 dBm/nm or greater than −20 dBm/nm.

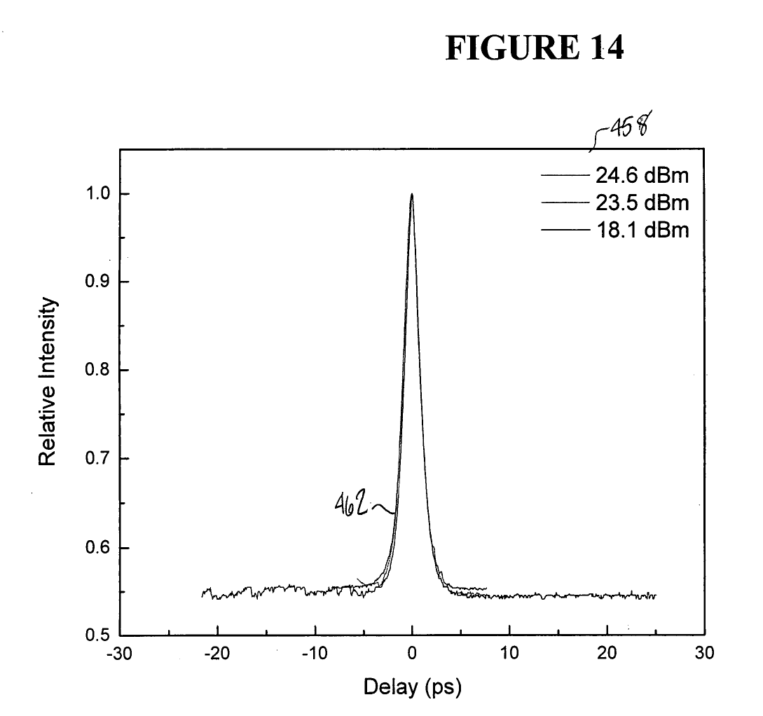

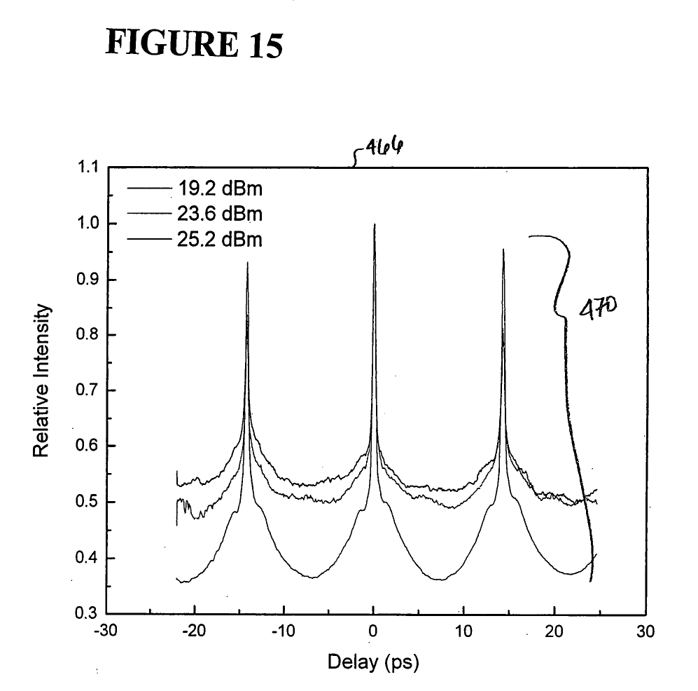

FIGS. 14 and 15 are diagrams 458 and 466 of graphs 462 and 470, respectively, illustrating example temporal autocorrelation. Graph 462 describes example temporal autocorrelation when laser diode 120a is off. Graph 462 exhibits a coherence peak roughly inversely proportional to the bandwidth shown in graph 258 of FIG. 8.

Graph 470 describes example temporal autocorrelation when laser diode 120a is on. Graph 470 exhibits sharp, narrow features that correspond to a periodic pulse train output, as expected for modulational instability. Moreover, the temporal spacing between peaks of approximately 15 psec is approximately equivalent to the reciprocal of the longitudinal mode spacing of laser diode 120a or 320, indicating that the longitudinal modes help seed the modulational instability process in this particular embodiment. As the output power is increased, the temporal peaks become sharper and more distinct from one another.

Graphs 462 and 470 indicate that supercontinuum light having a bandwidth greater than 100 nm may be initiated by modulational instability of pulses that are greater than 10 psec, more specifically, greater than 1.8 ns or 8 ns. Supercontinuum light initiated in this manner may be generated from laser diode based systems, without the need for modelocked lasers.

Referring back to FIG. 10, detectors 422 may generate other suitable detector data. According to one embodiment, detectors 422 may generate detector data for different parts of the spectrum. As a first example, the detector data may describe the spectrum and the autocorrelation around 1542 nm and 1564 nm. As a second example, a cross-correlation may be performed between the parts of the spectrum. The strength of the cross-correlation may indicate that the spectrum exists simultaneously, and temporal features may indicate that the two parts of the spectra remain coherent with each other. Different parts of the temporal profile in the 1.8 ns or 8 ns pulses give rise to different parts of the spectrum. In particular examples, the flat and smooth super-continuum spectrum may be attributable to the range of intensities in the pulse from the amplified laser diodes.

Modifications, additions, or omissions may be made to test system 400 without departing from the scope of the invention. The components of test system 400 may be integrated or separated according to particular needs. Moreover, the operations of test system 400 may be performed by more, fewer, or other modules. Additionally, operations of test system 400 may be performed using any suitable logic.

Certain embodiments of the invention may provide one or more technical advantages. A technical advantage of one embodiment may be that pulses of the light are broken into pulses having a shorter temporal duration. The pulses are then spectrally broadened to create supercontinuum light. The supercontinuum light may have a spectral width of approximately 150 nanometers (nm) or more. For example, the spectral width in this case may correspond to the 20 dB down (1%) from the peak spectral width. Another technical advantage of one embodiment may be that the supercontinuum light may be generated with a modulated pump laser, a fiber, and a nonlinear waveguide.

While this disclosure has been described in terms of certain embodiments and generally associated methods, alterations and permutations of the embodiments and methods will be apparent to those skilled in the art. Accordingly, the above description of example embodiments does not constrain this disclosure. Other changes, substitutions, and alterations are also possible without departing from the spirit and scope of this disclosure, as defined by the following claims.

What is claimed is:

1. A supercontinuum light source, comprising:
a modulated pump laser operable to:
generate light comprising a plurality of longer pulses, a longer pulse of the plurality of longer pulses having a temporal duration of approximately ten picoseconds or more;
a first fiber coupled to the modulated pump laser, the first fiber at least partially operating in an anomalous group velocity dispersion regime, the first fiber operable to:
break at least one longer pulse of the plurality of longer pulses into a plurality of shorter pulses, a shorter pulse of the plurality of shorter pulses having a temporal duration of approximately two picoseconds or less, the plurality of shorter pulses resulting from a modulational instability in the first fiber; and
a nonlinear waveguide coupled to the first fiber, the nonlinear waveguide operable to:
spectrally broaden at least some of the plurality of shorter pulses to yield supercontinuum light, the supercontinuum light having a spectral width of approximately 150 nanometers or more.

2. The supercontinuum light source of claim 1, wherein the modulated pump laser comprises:
one or more laser diodes coupled to an optical amplifier.

3. The supercontinuum light source of claim 1, wherein the modulated pump laser comprises:
one or more laser diodes, at least one laser diode of the laser diodes comprising a distributed feedback laser.

4. The supercontinuum light source of claim 1, wherein the modulated pump laser further comprises an amplifier selected from a group consisting of:
an erbium-doped fiber amplifier, a Raman amplifier, a semiconductor amplifier, and a rare-earth doped fiber amplifier.

5. The supercontinuum light source of claim 1, wherein the modulated pump laser comprises:
a filtering system operable to reduce amplified spontaneous emission.

6. The supercontinuum light source of claim 1, wherein the modulated pump laser comprises:
a filtering system operable to reduce amplified spontaneous emission, the filtering system comprising:
one or more wavelength filters; and
at least one temporal modulator substantially synchronized with the plurality of longer pulses.

7. The supercontinuum light source of claim 1, wherein the plurality of longer pulses have a wavelength of approximately 1.4 to 1.7 microns or more.

8. The supercontinuum light source of claim 1, wherein the plurality of longer pulses have a temporal duration of approximately 100 picoseconds or more.

9. The supercontinuum light source of claim 1, wherein the plurality of longer pulses have a temporal duration of approximately one nanosecond or more.

10. The supercontinuum light source of claim 1, wherein the first fiber is selected from a group consisting of:
a fused silica fiber, a high-nonlinearity fiber, an optical amplifier, an erbium-doped fiber, a photonic crystal fiber, a dispersion compensating fiber, a dispersion shifted fiber, a non-zero dispersion fiber, a dispersion flattened fiber, a patch-cord fiber, and a low bend loss fiber.

11. The supercontinuum light source of claim 1, wherein the nonlinear waveguide is selected from a group consisting of:
a small core fiber, a high-nonlinearity fiber, a photonic crystal fiber, a fluoride fiber, and a chalcogenide fiber.

12. The supercontinuum light source of claim 1, wherein the nonlinear waveguide is selected from a group consisting of:
a semiconductor waveguide and a tellurite fiber.

13. The supercontinuum light source of claim 1, wherein the nonlinear waveguide has a core size of approximately 30 microns or less.

14. A supercontinuum light source comprising:
a modulated pump laser operable to:
generate light comprising a plurality of longer pulses, a longer pulse of the plurality of longer pulses having a temporal duration of approximately ten picoseconds or more;
a first fiber coupled to the modulated pump laser, the first fiber at least partially operating in an anomalous group velocity dispersion regime, the first fiber operable to:
break at least one longer pulse of the plurality of longer pulses into a plurality of shorter pulses, a shorter pulse of the plurality of shorter pulses having a temporal duration of approximately two picoseconds or less, the plurality of shorter pulses resulting from a modulational instability in the first fiber; and
a nonlinear waveguide coupled to the first fiber, the nonlinear waveguide operable to:
spectrally broaden at least some of the plurality of shorter pulses to yield supercontinuum light, the supercontinuum light having a time-averaged spectral density of approximately −26 dBm/nm or more over at least a portion of a spectrum of the light.

15. The supercontinuum light source of claim 14, wherein the modulated pump laser further comprises an amplifier selected from a group consisting of:
an erbium-doped fiber amplifier, a Raman amplifier, a semiconductor amplifier, and a rare-earth doped fiber amplifier.

16. The supercontinuum light source of claim 14, further comprising:
an output operable to provide the supercontinuum light to an optical interferometer of an optical imaging system, the optical imaging system having a resolution of approximately 10 microns or less.

17. The supercontinuum light source of claim 14, further comprising:
an output operable to provide the supercontinuum light to a Michelson interferometer of an optical coherence tomography system, the optical coherence tomography system having a resolution of approximately 10 microns or less.

18. A method for generating supercontinuum light, comprising:
generating light comprising a plurality of longer pulses, a longer pulse of the plurality of longer pulses having a temporal duration of approximately ten picoseconds or more;
breaking at least one longer pulse of the plurality of longer pulses into a plurality of shorter pulses at a first fiber, a shorter pulse of the plurality of shorter pulses having a temporal duration of approximately two picoseconds or less, the first fiber at least partially operating in an anomalous group velocity dispersion regime, the plurality of shorter pulses resulting from a modulational instability in the first fiber; and
spectrally broadening at least some of the plurality of shorter pulses at a nonlinear waveguide to yield supercontinuum light, the supercontinuum light having a spectral width of approximately 150 nanometers or more.

19. The method of claim 18, wherein generating light comprising the plurality of longer pulses further comprises:
amplifying light generated by one or more laser diodes; and
filtering the amplified light to reduce amplified spontaneous emission.

20. The method of claim 18, wherein the nonlinear waveguide is selected from a group consisting of:
a small core fiber, a high-nonlinearity fiber, a photonic crystal fiber, a fluoride fiber, and a chalcogenide fiber.
